(19) United States
(12) Patent Application Publication
(10) Pub. No.: US 2014/0006418 A1
(43) Pub. Date: Jan. 2, 2014

(54) METHOD AND APPARATUS FOR RANKING APPS IN THE WIDE-OPEN INTERNET

(71) Applicants: ANDREA G. FORTE, Brooklyn, NY (US); BARIS COSKUN, Weehawken, NJ (US); QI SHEN, New York, NY (US); ILONA MURYNETS, Rutherford, NJ (US); JEFFREY BICKFORD, Somerset, NJ (US); MIKHAIL ISTOMIN, Brooklyn, NY (US); PAUL GIURA, Cairo, NY (US); ROGER PIQUERAS JOVER, New York, NY (US); RAMESH SUBBARAMAN, Jersey City, NJ (US); SUHAS MATHUR, Bayonne, NJ (US); WEI WANG, Hoboken, NJ (US)

(72) Inventors: ANDREA G. FORTE, Brooklyn, NY (US); BARIS COSKUN, Weehawken, NJ (US); QI SHEN, New York, NY (US); ILONA MURYNETS, Rutherford, NJ (US); JEFFREY BICKFORD, Somerset, NJ (US); MIKHAIL ISTOMIN, Brooklyn, NY (US); PAUL GIURA, Cairo, NY (US); ROGER PIQUERAS JOVER, New York, NY (US); RAMESH SUBBARAMAN, Jersey City, NJ (US); SUHAS MATHUR, Bayonne, NJ (US); WEI WANG, Hoboken, NJ (US)

(21) Appl. No.: 13/540,249

(22) Filed: Jul. 2, 2012

(51) Int. Cl. G06F 17/30

(52) U.S. Cl. 707/748; 707/E17.005

(57) ABSTRACT

A method, non-transitory computer readable medium and apparatus for ranking an application are disclosed. For example, the method collects meta-data from the application, determines a reputation of a developer of the application using the meta-data, and computes an initial ranking of the application based upon the reputation of the developer.

The present disclosure relates generally to applications and, more particularly, to a method and apparatus for ranking applications in the wide-open Internet.

### BACKGROUND

Mobile endpoint device use has increased in popularity in the past few years. Associated with the mobile endpoint devices are the proliferation of software applications (broadly known as “apps” or “applications”) that are created for the mobile endpoint device.

The number of available apps is growing at an alarming rate. Currently, hundreds of thousands of apps are available to users via app stores such as Apple's® app store and Google's® Android marketplace. With such a large number of available apps, it would be very time consuming for users to manually search for an app that is of interest to them.

Currently, a user can only search for an app in a rudimentary fashion. In addition, it is currently difficult to quickly determine if a particular app that a user has searched for is relevant to what the user was looking for or for a user to determine if the quality of the app can be trusted from a particular developer.

Furthermore, the apps that are found in response to the user's search may not be presented in any particular order. For example, the apps may be listed in an order based upon how much the developers pay to be ordered first or a simple alphabetical listing. This type of listing may not be helpful to the user.

### SUMMARY

In one embodiment, the present disclosure provides a method for ranking an application. For example, the method collects meta-data from the application, determines a reputation of a developer of the application using the meta-data, and computes an initial ranking of the application based upon the reputation of the developer.

### BRIEF DESCRIPTION OF THE DRAWINGS

The present disclosure can be readily understood by considering the following detailed description in conjunction with the accompanying drawings, in which:

FIG. 1 illustrates one example of a communications network of the present disclosure;

FIG. 2 illustrates an example functional framework flow diagram for application searching;

FIG. 3 illustrates an example flowchart of one embodiment of a method for ranking apps; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for ranking software applications (“apps”). The growing popularity of apps for mobile endpoint devices has lead to an explosion of the number of apps that are available. Currently, there are hundreds of thousands of apps available for mobile endpoint devices.

However, for a user to search for a particular app or browse through each one of the apps would be a very time consuming process. Currently, apps are presented to the user in an order that is not necessarily an order or ranking that is most useful to the user. One embodiment of the present disclosure ranks apps in an order that is most relevant to what the user is looking for and ensures that the apps are from developers that have a good reputation for providing the type of app the user is looking for.

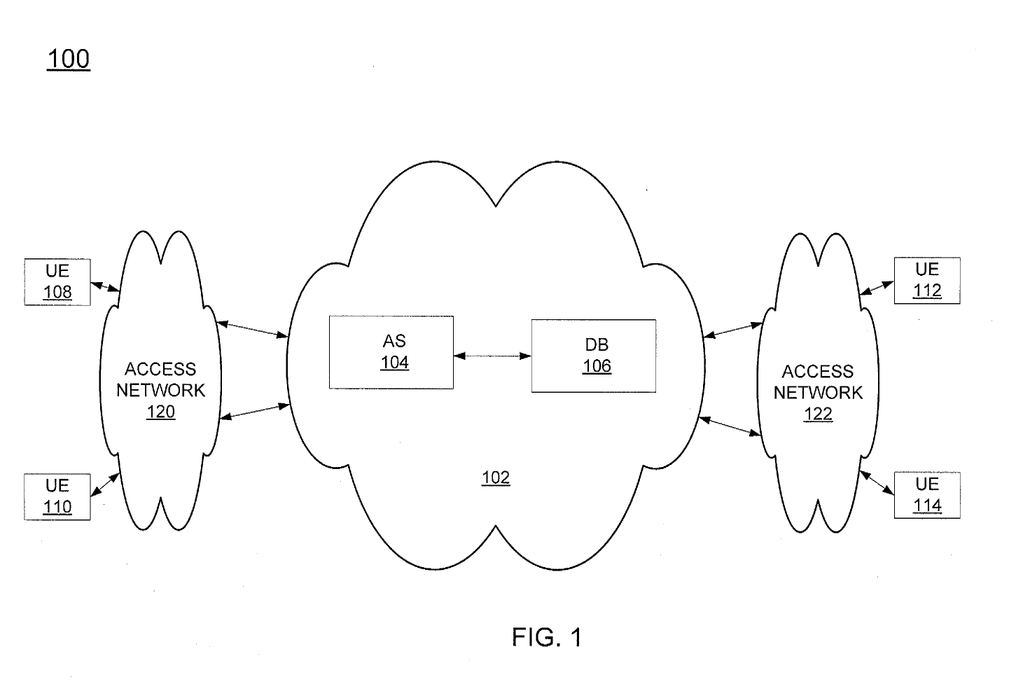

FIG. 1 is a block diagram depicting one example of a communications network 100. The communications network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network, an asynchronous transfer mode (ATM) network, a wireless network, a cellular network (e.g., 2G, 3G and the like), a long term evolution (LTE) network, and the like) related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like. It should be noted that the present disclosure is not limited by the underlying network that is used to support the various embodiments of the present disclosure.

In one embodiment, the network 100 may comprise a core network 102. The core network 102 may be in communication with one or more access networks 120 and 122. The access networks 120 and 122 may include a wireless access network (e.g., a WiFi network and the like), a cellular access network, a PSTN access network, a cable access network, a wired access network and the like. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one embodiment, the core network 102 may include an application server (AS) 104 and a database (DB) 106. Although only a single AS 104 and a single DB 106 are illustrated, it should be noted that any number of application servers 104 or databases 106 may be deployed.

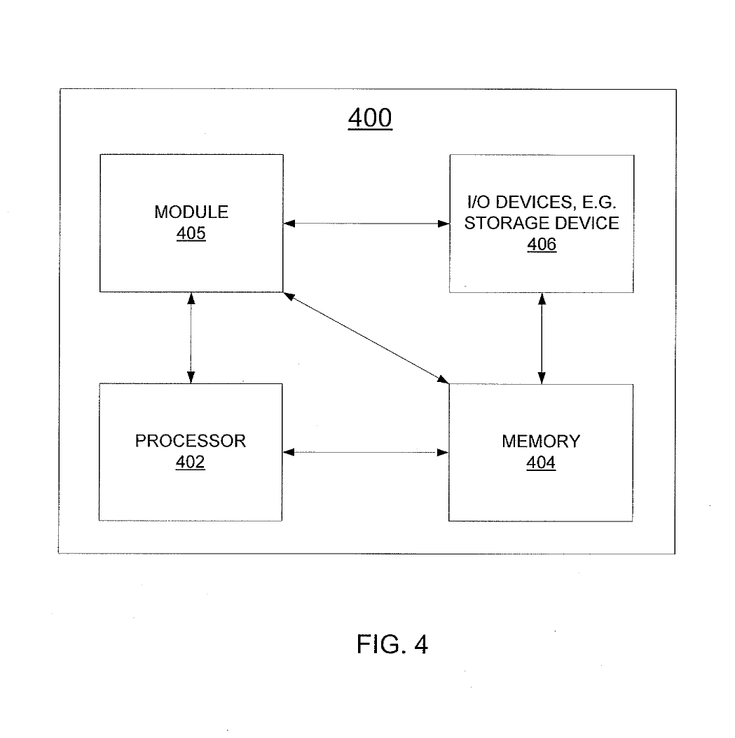

In one embodiment, the AS 104 may comprise a general purpose computer as illustrated in FIG. 4 and discussed below. In one embodiment, the AS 104 may perform the methods and algorithms discussed below related to ranking the apps.

In one embodiment, the DB 106 may store various indexing schemes used for searching. For example, the DB 106 may store indexing schemes such as text indexing, semantic indexing, context indexing, user feedback indexing and the like.

In one embodiment, the DB 106 may store various information related to apps. For example, as meta-data is extracted from the apps, the meta-data may be stored in the DB 106. The meta-data may include information such as a type of app, a developer of the app, app keywords and the like. The meta-data may then be used to search the Internet for additional information about the app, such as a reputation of the developer for creating the type of app being analyzed, and the like. The additional information obtained from searching the Internet may also be stored in the DB 106. In addition, the DB 106 may store all of the rankings that are computed.

In one embodiment, the DB 106 may also store a plurality of apps that may be accessed by a user via the user's endpoint device. In one embodiment, a plurality of databases storing a plurality of apps may be deployed. In one embodiment, the databases may be co-located or located remotely from one another throughout the communications network 100. In one embodiment, the plurality of databases may be operated by different vendors or service providers. Although only a single AS 104 and a single DB 106 are illustrated in FIG. 1, it should be noted that any number of application servers or databases may be deployed.

In one embodiment, the access network 120 may be in communication with one or more user endpoint devices (also referred to as “endpoint devices” or “UE”) 108 and 110. In one embodiment, the access network 122 may be in communication with one or more user endpoint devices 112 and 114.

In one embodiment, the user endpoint devices 108, 110, 112 and 114 may be any type of endpoint device such as a desktop computer or a mobile endpoint device such as a cellular telephone, a smart phone, a tablet computer, a laptop computer, a netbook, an ultrabook, a tablet computer, a portable media device (e.g., an iPod® touch or MP3 player), and the like. It should be noted that although only four user endpoint devices are illustrated in FIG. 1, any number of user endpoint devices may be deployed.

It should be noted that the network 100 has been simplified. For example, the network 100 may include other network elements (not shown) such as border elements, routers, switches, policy servers, security devices, a content distribution network (CDN) and the like.

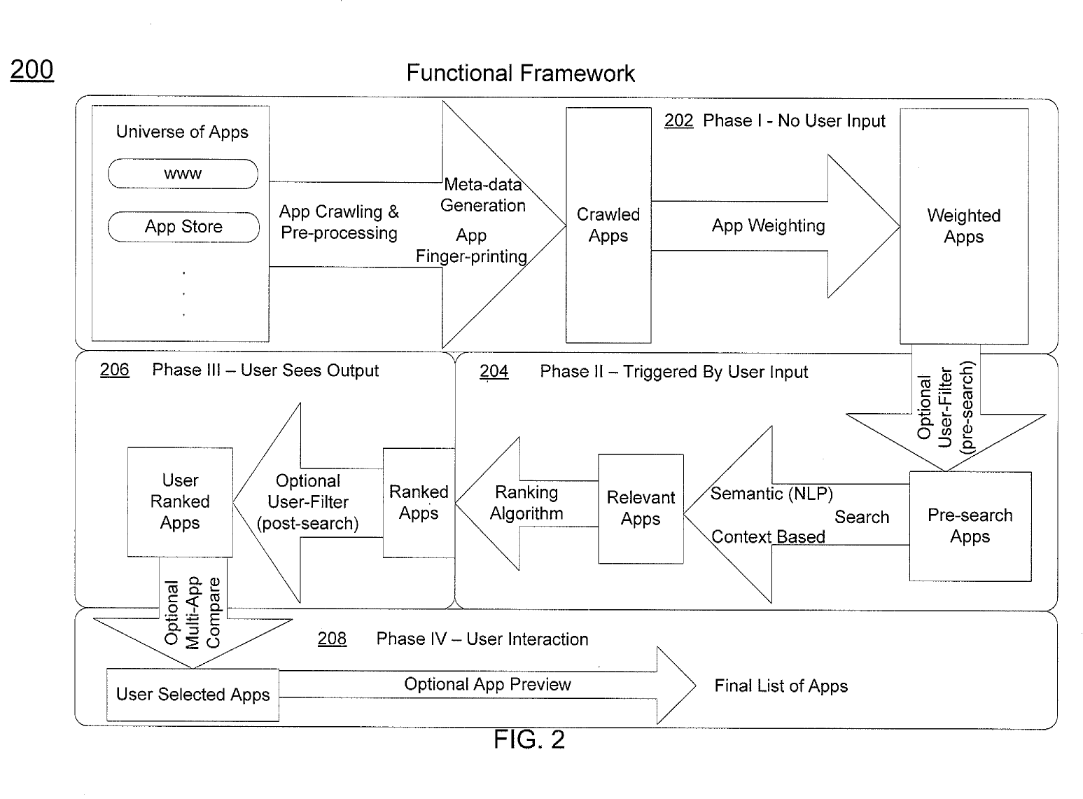

FIG. 2 illustrates an example of a functional framework flow diagram 200 for app searching. In one embodiment, the functional framework flow diagram 200 may be executed for example, in a communication network described in FIG. 1 above.

In one embodiment, the functional framework flow diagram 200 includes four different phases, phase I 202, phase II 1204, phase III 206 and phase IV 208. In phase I 202, operations are performed without user input. For example, from a universe of apps, phase I 202 may pre-process each one of the apps to obtain and/or generate meta-data and perform app fingerprinting to generate a “crawled app.” Apps may be located in a variety of online locations, for example, an app store, an online retailer, an app marketplace or individual app developers who provide their apps via the Internet, e.g., websites.

In one embodiment, meta-data may include information such as a type or category of the app, a name of the developer (individual or corporate entity) of the app, key words associated with the app and the like. In one embodiment, the meta-data information may then be further used to crawl the Internet or the World Wide Web to obtain additional information.

In one embodiment, using the meta-data, the reputation of a developer for developing particular types of apps may be obtained. For example, if the developer for a security app is a security company, the security company may have a high reputation for creating security apps. In contrast, if the developer for a database app is by a security company, the security company may have a low reputation for creating database apps.

The reputation may be calculated based on a number of different methods. In one embodiment, a web search on a particular topic or category associated with an app may have a set of ranked results. The ranking of the results may be an indication of a level of reputation of a developer for the particular topic or category. For example, if a search for “antivirus tools” is performed, one of the top results may be “Norton®”. Thus, Norton® may have a high reputation for apps related to “antivirus tools”.

In another embodiment, the reputation may be based on whether the developer has more positive comments than negative comments related to various categories or types of apps, the number of apps in a particular category the developer has developed, and the like.

The reputation information may then be used to calculate an initial ranking for each one of the apps. For example, based upon a reputation of the developer for developing a particular type of app, a weight value may be assigned to the app from a particular developer. For example, the weight may be a value between 0 and 1, where a highest reputation for developing a particular type of app may be assigned a value of 1 and a lowest reputation for developing a particular type of app may be assigned a value of 0. For example, if a developer only makes security apps, then a security app from this particular developer may be assigned a weighted value of 1. In another example, if two third of the apps developed by a developer are security apps and another third of the apps developed by the developer are productivity apps, the security app from this particular developer may be assigned a weighted value of 0.67 and the productivity app from this particular developer may be assigned a weighted value of 0.33. This is only an illustrative example.

The example above is only one example of a type of weighting system that may be used. However, the weights may be assigned using any appropriate method.

Once the apps are weighted and an initial ranking for each of the apps is computed, phase II 204 is triggered by user input. For example, during phase II 204 a user may input a search query for a particular app. In one embodiment, the search may be based upon a natural language processing (NLP) or semantic query. For example, the search may simply be a search based upon matches of keywords provided by the user in the search query. Using the NLP query, a NLP ranking of the app may be computed.

In one embodiment, the search may be based upon a context based query. For example, the search may be performed based upon context information associated with a user and context information associated with an app. In one embodiment, context information associated with the user may include which human senses are being used or are free. The context information associated with the user may also include what (an activity type parameter, e.g., a type of activity the user is participating in such as a particular type of sports activity, a particular work related activity, a particular school related activity and so on), where (a location parameter, e.g., a location of an activity, such as indoor, outdoor, at a particular location, at home, at work, and the like), when (a time parameter, e.g., a time of day, in the morning, in the afternoon, a day of the week, etc.) and with whom (a person parameter, e.g., a single user, a group of users, friends, family, an age of the user and the like) the user is performing an activity.

In one embodiment, the context information may be provided by a user. For example, via a web interface, the user may enter a search based upon context information or provide information as to what activity he or she is performing, who is with the user, and the like. Some examples of search phrases may include “apps to use while I'm driving,” “apps to use while I'm cooking,” “gaming apps for a large group of people,” and the like. In addition, the user may enter information on what senses are available. For example, the user may provide information that the user's hands are free or that the user may listen or interact verbally with an app, and the like.

In another embodiment, the context information may be automatically provided via one or more sensors on an endpoint device of the user. For example, the sensors may include a microphone, a video camera, a gyroscope, an accelerometer, a thermometer, a global positioning satellite (GPS) sensor, and the like. As a result, the endpoint may provide context information such as the user is moving based upon detection of movement by the accelerometer, who is in the room with the user based upon images captured by the video camera, where the user is based upon images captured by the video camera and location information from the GPS sensor, and the like.

In one embodiment, after the context information is processed from the search request, the context information of the user may be compared against the context information labeled in the apps. As discussed above, in phase I 202 the apps may be modified to include context information. Using the context information of the user from the search request and the context information labeled in the apps, the searching algorithm may provide in the search results apps that have matching context information or do not require the use of any of the senses that are being used. In other words, if the user's sense of sight/eyes is being used, then no apps that require the sense of sight/eyes would be returned in the search results.

To illustrate one example of a context search, the user may be cooking. The system may receive the context search request by requesting apps suitable for when they are cooking. In one embodiment, the algorithm may consider what senses are available while engaging in a particular activity and return apps that can be used with the available senses. In one embodiment, the search request may be processed to determine that cooking requires the use of the user's senses such as touch/hands and sight/eyes and that the senses of smell/nose, sound/ears, voice/mouth and mood/mind are available. Thus, the context based search may try to search for apps that allow the user to listen to the app, for example, a radio app, an audio book app, and the like.

Based on the senses required for the app and the senses that are available to the user, a weight value may be assigned to each app found in response to the context search. For example, if the user has the senses of hearing and sight available, then an app that only utilizes hearing may be assigned a weight value of 0.50. Alternatively, if an app utilizes the senses of hearing and sight, then the app may be assigned a weight value of 1.00. Based upon the context search a context based ranking of the apps may be calculated.

In one embodiment, user feedback may also be used to calculate a user feedback ranking. For example, user feedback may include data obtained during phase I 202 of user ratings of a particular app or feedback collected from users that have previously used the final ranking algorithm with respect to how accurate the final rankings of the apps were.

A ranking algorithm may be applied to the apps that accounts for at least the initial ranking to compute a final ranking of the apps. In one embodiment, the final ranking may be calculated based upon the initial ranking, the context based ranking, the NLP ranking and/or the user feedback ranking. For example, the weight values of each of the rankings may be added together to compute a total weight value, which may then be compared to the total weight values of the other apps.

At phase III 206, the results of the final ranking are presented to the user. During phase III 206, the user may apply one or more optional post search filters to the ranked apps, e.g., various filtering criteria such as cost, hardware requirement, popularity of the app, other users' feedback, and so on. The post search filters may then be applied to the relevant ranked apps to generate a final set of apps that will be presented to the user.

At phase IV 208, the user may interact with the apps. For example, the user may select one of the apps and either preview the app or download the app for installation and execution on the user's endpoint device.

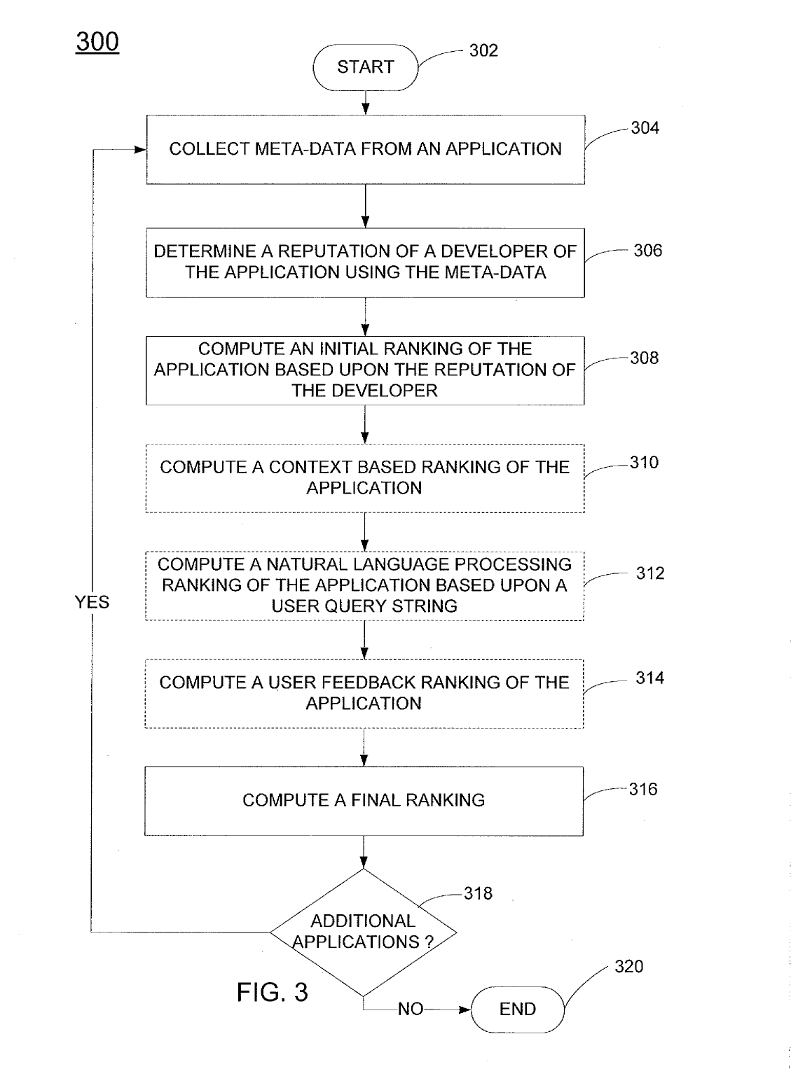

FIG. 3 illustrates a flowchart of a method 300 for ranking apps. In one embodiment, the method 300 may be performed by the AS 104 or a general purpose computing device as illustrated in FIG. 4 and discussed below.

The method 300 begins at step 302. At step 304, the method 300 collects meta-data from an app. For example, the meta-data may include information such as a type or category of the app, a developer of the app, key words associated with the app and the like. The meta-data information may then be used to crawl the Internet or the World Wide Web to obtain additional information.

At step 306, the method 300 determines a reputation of a developer of the app using the meta-data. For example, the information about the developer from the meta-data may be used to perform a search on the developer with respect to a particular category of app. The search result may include a ranking. The ranking of the search results may be used to determine a reputation of the developer. For example, if the developer has the highest ranking result, then the developer may have a high reputation for the particular category of app.

The reputation of the developer may be determined using other methods described above as well. For example, whether the developer has more positive comments than negative comments related to various categories or types of apps, the number of apps in a particular category the developer has developed, and the like.

At step 308, the method 300 computes an initial ranking of the app based upon the reputation of the developer. For example, as discussed above, using the meta-data a developer's reputation for developing a particular type of app or category of app may be obtained. Using the reputation, a weight may be assigned to the app. Using the weight and reputation of the developer for the type of app that is presently being analyzed an initial ranking may be computed.

The method 300 may then perform optional steps 310, 312 and 314 or proceed straight to step 316. In one embodiment, one of the steps 310, 312 and 314 may be performed, all of the steps 310, 312 and 314 may be performed or any combination of steps 310, 312 and 314 may be performed.

At step 310, the method 300 may compute a context based ranking of the app. For example, as discussed above, the search may be performed based upon what, where, when and with whom a user is performing an activity. For example, the user may be cooking. Thus, the user's physical senses and sight senses may be occupied by the cooking activity. However, the user's hearing sense may be free. Thus, the context based search may try to search for apps that allow the user to listen to the app, for example, a radio app, an audio book app, and the like. A weight value may be assigned to the app based on how well the app matches the context search. Based upon the weight value a context based ranking of the apps may be calculated.

At step 312, the method 300 may compute an NLP ranking of the app based upon a user query string. For example, the search may simply be a search based upon matches of keywords provided by the user in the search query. For example, a weight value may be assigned to the apps based on how well the app matches the NLP query. Using the weight value, an NLP ranking of the app may be computed.

At step 314, the method 300 may compute a user feedback ranking of the app. For example, user feedback may include data obtained during phase 202 of user ratings of a particular app or feedback collected from users that have previously used the final ranking algorithm with respect to how accurate the final rankings of the apps were. A weight value may be assigned to the app based on how high or low the user feedback is.

At step 316, the method 300 computes a final ranking of the app. In one embodiment, the final ranking may be computed based upon at least the initial ranking. In one embodiment, the final ranking may be calculated based upon the initial ranking, the context based ranking, the NLP ranking and/or the user feedback ranking. For example, the weight values of each of the rankings may be added together to compute a total weight value for the final ranking.

At step 318, the method 300 determines if there are additional apps that need to be analyzed to have a final ranking computed. If there are additional apps, the method 300 may go back to step 304 and the method 300 may be repeated for each one of the apps. If there are no additional apps, then the method 300 may proceed to step 320 where the method 300 ends.

As a result, the apps are ranked in an order that is most relevant to the user with respect to who has developed the app and based upon a type of search the user has requested (e.g., NLP search, context search, and the like). In other words, apps that are developed by developers that have no reputations for creating a particular type of app may be presented to a user at a bottom portion of a ranked list of apps. In addition, the apps are ranked in an order that is most appropriate for their activity.

It should be noted that although not explicitly specified, one or more steps of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, operations, steps or blocks in FIG. 3 that recite a determining operation, or involve a decision, do not necessarily require that both branches of the determining operation be practiced. In other words, one of the branches of the determining operation can be deemed as an optional step. Furthermore, operations, steps or blocks of the above described methods can be combined, separated, and/or performed in a different order from that described above, without departing from the example embodiments of the present disclosure.

FIG. 4 depicts a high-level block diagram of a general-purpose computer suitable for use in performing the functions described herein. As depicted in FIG. 4, the system 400 comprises a hardware processor element 402 (e.g., a CPU), a memory 404, e.g., random access memory (RAM) and/or read only memory (ROM), a module 405 for ranking apps, and various input/output devices 406, e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 405 for ranking apps can be implemented as computer-executable instructions (e.g., a software program comprising computer-executable instructions) and loaded into memory 404 and executed by hardware processor 402 to implement the functions as discussed above. As such, the present method 405 for ranking apps as discussed above in method 300 (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for ranking an application, comprising:
collecting meta-data from the application;
determining a reputation of a developer of the application using the meta-data; and
computing an initial ranking of the application based upon the reputation of the developer.

2. The method of claim 1, wherein the meta-data includes information about the developer of the application.

3. The method of claim 1, wherein the reputation of the developer is determined based upon a ranking of the developer in a search result for a topic associated with the application.

4. The method of claim 1, wherein the computing the initial ranking comprises assigning a weighted value to the application.

5. The method of claim 1, further comprising:
computing a context based ranking of the application; and
computing a final ranking of the application based upon the initial ranking of the application and the context based ranking of the application.

6. The method of claim 5, wherein the context based ranking is based upon a relevance of the application as to what, where, when and with whom a user is performing an activity.

7. The method of claim 1, further comprising:
computing a natural language processing ranking of the application based upon a user query string; and
computing a final ranking of the application based upon the initial ranking of the application and the natural language processing ranking of the application.

8. The method of claim 1, further comprising:
computing a user feedback ranking of the application; and
computing a final ranking of the application based upon the initial ranking of the application and the user feedback ranking of the application.

9. The method of claim 1, wherein the method is repeated for each one of a plurality of applications.

10. The method of claim 9, wherein a final ranking of the application is a relative ranking against other applications of the plurality of applications.

11. A non-transitory computer-readable medium having stored thereon a plurality of instructions, the plurality of instructions including instructions which, when executed by a processor, cause the processor to perform operations for ranking an application, the operations comprising:
collecting meta-data from the application;
determining a reputation of a developer of the application using the meta-data; and
computing, via a processor, an initial ranking of the application based upon the reputation of the developer.

12. The non-transitory computer-readable medium of claim 11, wherein the meta-data includes information about the developer of the application.

13. The non-transitory computer-readable medium of claim 11, wherein the reputation of the developer is determined based upon a ranking of the developer in a search result for a topic associated with the application.

14. The non-transitory computer-readable medium of claim 11, wherein the computing the initial ranking comprises assigning a weighted value to the application.

15. The non-transitory computer-readable medium of claim 11, further comprising:
computing a context based ranking of the application; and
computing a final ranking of the application based upon the initial ranking of the application and the context based ranking of the application.

16. The non-transitory computer-readable medium of claim 15, wherein the context based ranking is based upon a relevance of the application as to what, where, when and with whom a user is performing an activity.

17. The non-transitory computer-readable medium of claim 11, further comprising:
computing a natural language processing ranking of the application based upon a user query string; and
computing a final ranking of the application based upon the initial ranking of the application and the natural language processing ranking of the application.

18. The non-transitory computer-readable medium of claim 11, further comprising:
computing a user feedback ranking of the application; and
computing a final ranking of the application based upon the initial ranking of the application and the user feedback ranking of the application.

19. The non-transitory computer-readable medium of claim 11, wherein the method is repeated for each one of a plurality of applications, and wherein a final ranking of the application is a relative ranking against other applications of the plurality of applications.

20. An apparatus for ranking an application, comprising:
a processor; and
a computer-readable medium in communication with the processor, wherein the computer-readable medium has stored thereon a plurality of instructions, the plurality of instructions including instructions which, when executed by the processor, cause the processor to perform operations, the operations comprising:
collecting meta-data from the application;
determining a reputation of a developer of the application using the meta-data; and
computing an initial ranking of the application based upon the reputation of the developer.
